(19) United States
(12) Patent Application Publication
(10) Pub. No.: US 2010/0187170 A1
(43) Pub. Date: Jul. 29, 2010

(54) APPARATUS FOR WATER PURIFICATION

(76) Inventor: Yung-Chih LIN, Taipei City (TW)

Correspondence Address: Muncy, Geissler, Olds & Lowe, PLLC, 4000 Legato Road, Suite 310, FAIRFAX, VA, 22033, US

(21) Appl. No.: 12/358,650

(22) Filed: Jan. 23, 2009

(51) Int. Cl. C02F 9/04; C02F 1/32; B01J 19/12; B01J 35/06; C02F 1/28

(52) U.S. Cl. 210/195.2; 210/259; 210/252; 210/195.1

(57) ABSTRACT

An apparatus for water purification is provided. The first aspect of the apparatus for water purification includes at least a water processing unit in connection with a water supply end, and a photocatalyst fiber processing unit having two ends in connection with the water processing unit and a water outlet end, respectively. The second aspect of the apparatus for water purification includes at least a water processing unit in connection with a first water tank, and a photocatalyst fiber processing unit having two ends in connection with the water processing unit and the first water tank, or in connection with the water processing unit and a second water tank, respectively, with the second water tank being in connection with the water processing unit. Therefore, the apparatus for water purification eliminates impurities and bacteria from water but preserves minerals in water.

### FIELD OF THE INVENTION

The present invention relates to an apparatus for water purification and, more particularly, to an apparatus for water purification with a photocatalyst fiber processing unit and a water processing unit.

### DESCRIPTION OF THE PRIOR ART

Today human beings' needs increase with living standard. For example, we want organic foods free of residual fertilizers, living environment free of noise pollution, home space with moderate temperature and humidity, water clean and pollution-free, etc. Water is a kind of substance indispensable to human beings' daily life, for example, for a cleaning purpose, for replenishing water that has been used up, for cooking, etc. Among the aforesaid purposes, drinking and cooking are of vital importance to humankind when it comes to water, primarily because environmental pollution caused by the burgeoning industry and commerce has an immediate impact on the quality of water resources. Hence, plenty enterprises endeavor to develop an apparatus for water purification in an attempt to enable people to acquire clean, pollution-free water at any time. However, conventional apparatuses for water purification, developed by existing enterprises, remove impurities from water (and even kill bacteria in water) along with minerals which might otherwise be present in the water. The fact is that water-based minerals, such as calcium, magnesium, sodium, iron, fluorine, etc., are wholesome foods for every human being, and their long-term deficiency is harmful to health.

Accordingly, an urgent issue to be addressed by the present invention involves developing an apparatus for water purification so as to eliminate impurities and bacteria from water but preserve minerals in water.

### SUMMARY OF THE INVENTION

In view of the shortcomings of the conventional apparatus for water purification, the inventor of the present invention believes that there is room for improvement in the conventional apparatus for water purification and finally succeeded, based on years of practical experience and after conducting pertinent research and experiments, in developing an apparatus for water purification with a view to eliminating impurities and bacteria from water but preserving minerals in water.

The primary objective of the present invention is to provide an apparatus for water purification with a water processing unit and a photocatalyst fiber processing unit so as to eliminate impurities and bacteria from water but preserve minerals in water.

To achieve the above objectives, the first aspect of an apparatus for water purification of the present invention comprises: at least a water processing unit in connection with a water supply end; and a photocatalyst fiber processing unit having two ends in connection with the water processing unit and a water outlet end.

The water processing unit is a ceramic biochar processing unit, an activated carbon processing unit, or a reverse osmosis processing unit.

Alternatively, the water processing units are a ceramic biochar processing unit and an activated carbon processing unit, respectively. The ceramic biochar processing unit connects with the water supply end. The activated carbon processing unit connects with the ceramic biochar processing unit. The photocatalyst fiber processing unit has two ends in connection with the activated carbon processing unit and the water outlet end.

The second aspect of an apparatus for water purification of the present invention comprises: at least a water processing unit in connection with a first water tank; and a photocatalyst fiber processing unit having two ends in connection with the water processing unit and the first water tank, respectively, or in connection with the water processing unit and a second water tank, respectively, with the second water tank being in connection with the water processing unit.

The water processing unit is a ceramic biochar processing unit, an activated carbon processing unit, or a reverse osmosis processing unit.

Alternatively, the water processing units are a ceramic biochar processing unit and an activated carbon processing unit, respectively. The ceramic biochar processing unit connects with the first water tank. The activated carbon processing unit connects with the ceramic biochar processing unit. The photocatalyst fiber processing unit has two ends in connection with the activated carbon processing unit and the first water tank, respectively, or in connection with the activated carbon processing unit and a second water tank, respectively, with the second water tank being in connection with the ceramic biochar processing unit.

The photocatalyst fiber processing unit comprises an ultraviolet light tube, a quartz tube, and a photocatalyst fiber layer. The ultraviolet light tube is enclosed by the quartz tube. The quartz tube is enclosed by the photocatalyst fiber layer. The photocatalyst fiber layer is made of titanium dioxide.

The ceramic biochar processing unit described above comprises a biochar and a ceramic casing. The ceramic casing has a plurality of pores and encloses the biochar.

The apparatus for water purification of the present invention eliminates impurities and bacteria from water but preserves minerals in water.

### BRIEF DESCRIPTION OF THE DRAWINGS

FIG. 1 is a schematic view of a preferred embodiment of a first aspect of the present invention;

FIG. 2 is a schematic view of another preferred embodiment of the first aspect of the present invention;

FIG. 3 is a schematic view of a preferred embodiment of a second aspect of the present invention;

FIG. 4 is a schematic view of another preferred embodiment of the second aspect of the present invention;

FIG. 5 is a schematic view of yet another preferred embodiment of the second aspect of the present invention; and

FIG. 6 is a schematic view of a further preferred embodiment of the second aspect of the present invention.

FIG. 7 is a schematic view of a photocatalyst fiber processing unit of the present invention.

FIG. 8 is a schematic view of a ceramic biochar processing unit of the present invention.

### DETAILED DESCRIPTION OF THE EMBODIMENTS

The present invention is herein illustrated with preferred embodiments in conjunction with the accompanying drawings, so that one skilled in the pertinent art can easily understand other objectives, features, advantages and effects of the present invention from the disclosure of the invention.

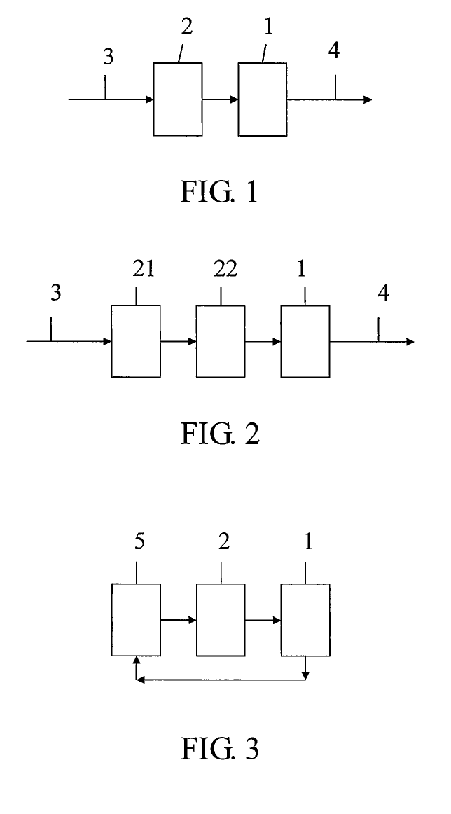

Referring to FIG. 1, which is a schematic view of a preferred embodiment of a first aspect of the present invention, the first aspect of the apparatus for water purification of the present invention comprises at least a water processing unit 2 and a photocatalyst fiber processing unit 1. The water processing unit 2 connects with a water supply end 3. The photocatalyst fiber processing unit 1 has two ends in connection with the water processing unit 2 and a water outlet end 4, respectively. The main purpose of the water processing unit 2 is to eliminate impurities from water and add minerals to water. The main purpose of the photocatalyst fiber processing unit 1 is to eliminate bacteria from water. The water supply end 3 is connected to a water-supply pipeline provided by a water supply plant, for example. The water outlet end 4 is connected to a water-supply pipeline for domestic use. The water processing unit 2 is a ceramic biochar processing unit for adding minerals to water, an activated carbon processing unit for eliminating impurities from water, or a reverse osmosis processing unit for eliminating impurities from water.

Referring to FIG. 2, which is a schematic view of another preferred embodiment of the first aspect of the present invention, the water processing unit 2 of the first aspect of the apparatus for water purification of the present invention is replaced with a ceramic biochar processing unit 21 and an activated carbon processing unit 22. The ceramic biochar processing unit 21 connects with the water supply end 3. The activated carbon processing unit 22 connects with the ceramic biochar processing unit 21. The two ends of the photocatalyst fiber processing unit 1 are in connection with the activated carbon processing unit 22 and the water outlet end 4, respectively. In so doing, water supplied by a water supply plant is enriched with minerals by means of the ceramic biochar processing unit 21, has impurities removed therefrom by means of the activated carbon processing unit 22, and has bacteria removed therefrom by means of the photocatalyst fiber processing unit 1. As a result, drinking water supplied to households is free of impurities and bacteria but retains its minerals.

Referring to FIG. 3, which is a schematic view of a preferred embodiment of a second aspect of the present invention, a second aspect of the apparatus for water purification of the present invention comprises at least a water processing unit 2 and a photocatalyst fiber processing unit 1. The water processing unit 2 connects with a first water tank 5. The photocatalyst fiber processing unit 1 has two ends in connection with the water processing unit 2 and the first water tank 5, respectively. The main purpose of water processing unit 2 is to eliminate impurities from water and add minerals to water. The main purpose of the photocatalyst fiber processing unit 1 is to eliminate bacteria from water. The first water tank 5 is a top-floor water tower for storing water supplied by a water supply plant. Furthermore, the water processing unit 2 is a ceramic biochar processing unit for adding minerals to water, an activated carbon processing unit for eliminating impurities from water, or a reverse osmosis processing unit for eliminating impurities from water.

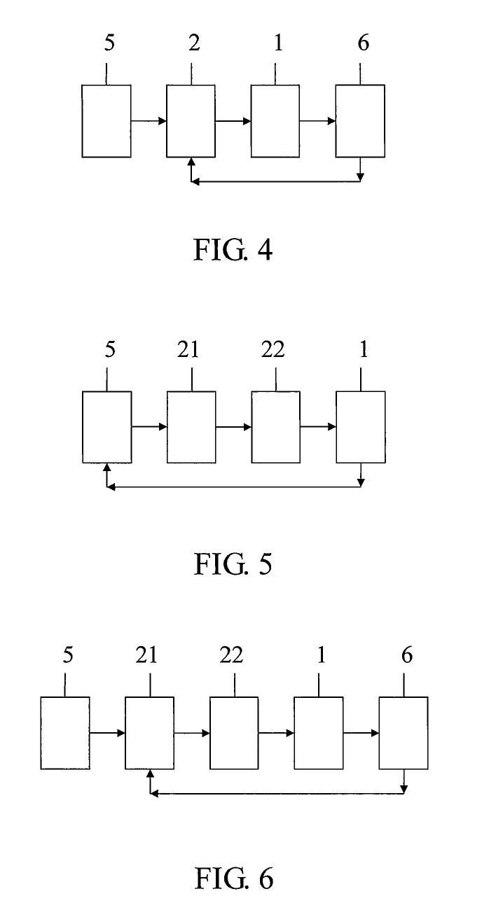

Referring to FIG. 4, which is a schematic view of another preferred embodiment of the second aspect of the present invention, another preferred embodiment of the second aspect of the apparatus for water purification of the present invention comprises at least a water processing unit 2 and a photocatalyst fiber processing unit 1. The water processing unit 2 connects with a first water tank 5. The two ends of the photocatalyst fiber processing unit 1 are in connection with the water processing unit 2 and a second water tank 6, respectively, with the second water tank 6 being in connection with the water processing unit 2. The main purpose of the water processing unit 2 is to eliminate impurities from water and add minerals to water. The main purpose of the photocatalyst fiber processing unit 1 is to eliminate bacteria from water. The first water tank 5 is a top-floor water tower for storing water supplied by a water supply plant. The second water tank 6 is a spare water tower for storing filtered water. Furthermore, the water processing unit 2 is a ceramic biochar processing unit for adding minerals to water, an activated carbon processing unit for eliminating impurities from water, or a reverse osmosis processing unit for eliminating impurities from water.

Referring to FIG. 5, which is a schematic view of yet another preferred embodiment of the second aspect of the present invention, the water processing unit 2 in yet another preferred embodiment of the second aspect of the apparatus for water purification of the present invention is replaced with a ceramic biochar processing unit 21 and an activated carbon processing unit 22. The ceramic biochar processing unit 21 connects with the first water tank 5. The activated carbon processing unit 22 connects with the ceramic biochar processing unit 21. The two ends of the photocatalyst fiber processing unit 1 are in connection with the activated carbon processing unit 22 and the first water tank 5, respectively. In so doing, water stored in the first water tank 5 (e.g., a water tower) is enriched with minerals by means of the ceramic biochar processing unit 21, has impurities removed therefrom by means of the activated carbon processing unit 22, and has bacteria removed therefrom by means of the photocatalyst fiber processing unit 1. As a result, water stored in the first water tank 5 (e.g., a water tower) is free of impurities and bacteria but retains minerals. Furthermore, in this preferred embodiment, removal of impurities and bacteria from and addition of minerals to water stored in the first water tank 5 (e.g., a water tower) are continuous so as to ensure that water quality is always up to standard.

Referring to FIG. 6, which is a schematic view of a further preferred embodiment of the second aspect of the present invention, the water processing unit 2 in a further preferred embodiment of the second aspect of the apparatus for water purification of the present invention is replaced with a ceramic biochar processing unit 21 and an activated carbon processing unit 22. The ceramic biochar processing unit 21 connects with the first water tank 5. The activated carbon processing unit 22 connects with the ceramic biochar processing unit 21. The two ends of the photocatalyst fiber processing unit 1 are in connection with the activated carbon processing unit 22 and a second water tank 6, respectively, with the second water tank 6 being in connection with the ceramic biochar processing unit 21. In so doing, water stored in the first water tank 5 (e.g., a water tower) is enriched with minerals by means of the ceramic biochar processing unit 21, has impurities removed therefrom by means of the activated carbon processing unit 22, and has bacteria removed therefrom by means of the photocatalyst fiber processing unit 1. As a result, water stored in the second water tank 6 (e.g., a spare water tower) is free of impurities and bacteria but retains minerals. Furthermore, in this preferred embodiment, removal of impurities and bacteria from and addition of minerals to water stored in the second water tank 6 (e.g., a spare water tower) are continuous so as to ensure that water quality is always up to standard.

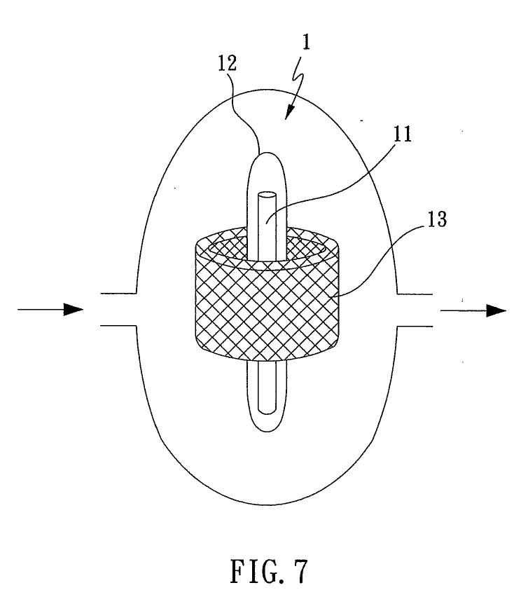

Referring to FIG. 7, which is a schematic view of a photocatalyst fiber processing unit of the present invention, the photocatalyst fiber processing unit 1 described above comprises an ultraviolet light tube 11, a quartz tube 12, and a photocatalyst fiber layer 13. The ultraviolet light tube 11 is enclosed by the quartz tube 12 and thereby insulated from water. The quartz tube 12 is surrounded by the photocatalyst fiber layer 13. The photocatalyst fiber layer 13 is made of titanium dioxide. Upon exposure to ultraviolet (UV) irradiation from the ultraviolet light tube 11, the photocatalyst fiber layer 13 undergoes a catalytic reaction whereby cell walls of bacteria are damaged and then the bacteria are annihilated.

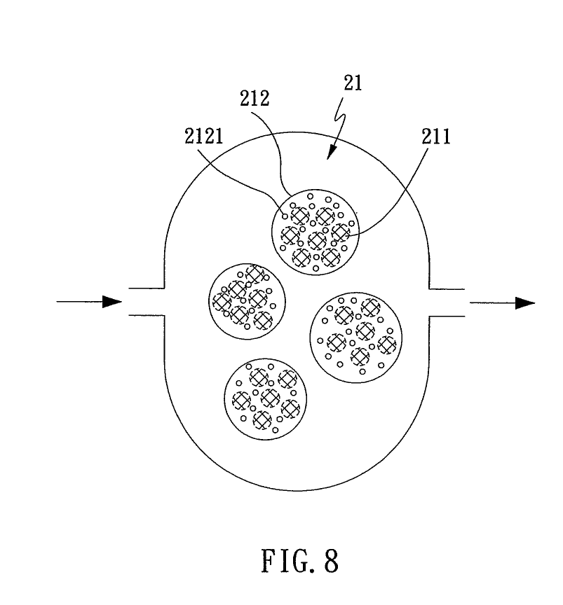

Referring to FIG. 8, which is a schematic view of a ceramic biochar processing unit of the present invention, the ceramic biochar processing unit 21 described above comprises a biochar 211 and a ceramic casing 212. The ceramic casing 212 has a plurality of pores 2121 and encloses the biochar 211. Water passes the pores 2121 to come into contact with the biochar 211, allowing minerals of the biochar 211 to be added to water.

The first aspect of the apparatus for water purification of the present invention is installed between a water supply end and a water outlet end of ordinary household facilities without causing any change in other pipelines. The second aspect of the apparatus for water purification of the present invention is installed between a top-floor water tower and a water outlet end or between a water tower and a spare water tower without causing any change in other pipelines.

Hence, the present invention meets the three requirements for patentability, namely novelty, an inventive step, and industrial applicability. Regarding novelty and an inventive step, the present invention discloses the water processing unit and the photocatalyst fiber processing unit for eliminating impurities and bacteria from water but retaining minerals in water. Regarding industrial applicability, any products derived from the present invention should be capable of meeting the current market needs to the full.

The aforesaid preferred embodiments are only illustrative of the features and functions of the present invention but are not intended to restrict the scope of the present invention. It is apparent to those skilled in the art that all equivalent modifications and replacement made in the aforesaid preferred embodiments according to the spirit and principle in the disclosure of the present invention should fall within the scope of the present invention. Accordingly, the scope of the present invention should be defined with the appended claims.

What is claimed is:

1. An apparatus for water purification, comprising:
at least a water processing unit in connection with a water supply end; and
a photocatalyst fiber processing unit having two ends in connection with the water processing unit and a water outlet end.

2. The apparatus for water purification of claim 1, wherein the water processing unit is one selected from the group consisting of a ceramic biochar processing unit, an activated carbon processing unit, or a reverse osmosis processing unit.

3. The apparatus for water purification of claim 1, wherein the water processing units are a ceramic biochar processing unit and an activated carbon processing unit, respectively, the ceramic biochar processing unit connecting with the water supply end, the activated carbon processing unit connecting with the ceramic biochar processing unit, the photocatalyst fiber processing unit having two ends in connection with the activated carbon processing unit and the water outlet end, respectively.

4. An apparatus for water purification, comprising:
at least a water processing unit in connection with a first water tank; and
a photocatalyst fiber processing unit having two ends in connection with the water processing unit and the first water tank, respectively, or in connection with the water processing unit and a second water tank, with the second water tank being in connection with the water processing unit.

5. The apparatus for water purification of claim 4, wherein the water processing unit is one selected from the group consisting of a ceramic biochar processing unit, an activated carbon processing unit, or a reverse osmosis processing unit.

6. The apparatus for water purification of claim 4, wherein the water processing units are a ceramic biochar processing unit and an activated carbon processing unit, respectively, the ceramic biochar processing unit connecting with the first water tank, the activated carbon processing unit connecting with the ceramic biochar processing unit, the photocatalyst fiber processing unit having two ends in connection with the activated carbon processing unit and the first water tank, respectively, or in connection with the activated carbon processing unit and a second water tank, respectively, with the second water tank 6 being in connection with the ceramic biochar processing unit.

7. The apparatus for water purification of claims 1, wherein the photocatalyst fiber processing unit comprises an ultraviolet light tube, a quartz tube, and a photocatalyst fiber layer, the ultraviolet light tube being enclosed by the quartz tube, and the quartz tube being surrounded by the photocatalyst fiber layer, the photocatalyst fiber layer is made of titanium dioxide.

8. The apparatus for water purification of claims 2, wherein the photocatalyst fiber processing unit comprises an ultraviolet light tube, a quartz tube, and a photocatalyst fiber layer, the ultraviolet light tube being enclosed by the quartz tube, and the quartz tube being surrounded by the photocatalyst fiber layer, the photocatalyst fiber layer is made of titanium dioxide.

9. The apparatus for water purification of claims 3, wherein the photocatalyst fiber processing unit comprises an ultraviolet light tube, a quartz tube, and a photocatalyst fiber layer, the ultraviolet light tube being enclosed by the quartz tube, and the quartz tube being surrounded by the photocatalyst fiber layer, the photocatalyst fiber layer is made of titanium dioxide.

10. The apparatus for water purification of claims 4, wherein the photocatalyst fiber processing unit comprises an ultraviolet light tube, a quartz tube, and a photocatalyst fiber layer, the ultraviolet light tube being enclosed by the quartz tube, and the quartz tube being surrounded by the photocatalyst fiber layer, the photocatalyst fiber layer is made of titanium dioxide.

11. The apparatus for water purification of claims 5, wherein the photocatalyst fiber processing unit comprises an ultraviolet light tube, a quartz tube, and a photocatalyst fiber layer, the ultraviolet light tube being enclosed by the quartz tube, and the quartz tube being surrounded by the photocatalyst fiber layer, the photocatalyst fiber layer is made of titanium dioxide.

12. The apparatus for water purification of claims 6, wherein the photocatalyst fiber processing unit comprises an ultraviolet light tube, a quartz tube, and a photocatalyst fiber layer, the ultraviolet light tube being enclosed by the quartz tube, and the quartz tube being surrounded by the photocatalyst fiber layer, the photocatalyst fiber layer is made of titanium dioxide.

13. The apparatus for water purification of claim 2, wherein the ceramic biochar processing unit comprises a biochar and a ceramic casing, the ceramic casing having a plurality of pores and enclosing the biochar.

14. The apparatus for water purification of claim 3, wherein the ceramic biochar processing unit comprises a biochar and a ceramic casing, the ceramic casing having a plurality of pores and enclosing the biochar.

15. The apparatus for water purification of claim 5, wherein the ceramic biochar processing unit comprises a biochar and a ceramic casing, the ceramic casing having a plurality of pores and enclosing the biochar.

16. The apparatus for water purification of claim 6, wherein the ceramic biochar processing unit comprises a biochar and a ceramic casing, the ceramic casing having a plurality of pores and enclosing the biochar.
